(19) United States
(12) Patent Application Publication
(10) Pub. No.: US 2003/0193148 A1
(43) Pub. Date: Oct. 16, 2003

(54) Clamping chuck, notably expansion chuck

(76) Inventors: Michael Haag, Abstatt (DE); Herbert Clauss, Lauffen (DE)

Correspondence Address: Joseph W. Berenato, III, Liniak, Berenato & White, LLC, Suite 240, 6550 Rock Spring Drive, Bethesda, MD, 20817, US

(21) Appl. No.: 10/429,879

(22) Filed: May 6, 2003

Related U.S. Application Data
(63) Continuation of application No. 09/762,941, filed on Apr. 9, 2001.
Application No. 09/762,941 is a 371 of international application No. PCT/EP99/05654, filed on Aug. 4, 1999.

(30) Foreign Application Priority Data
Aug. 14, 1998 (DE) 198 36 912.3

(51) Int. Cl. B23B 31/10; B23B 31/30; B23B 5/22

(52) U.S. Cl. 279/4.03

(57) ABSTRACT

The invention concerns a clamping chuck in which is embodied a central receptacle (4) for the shank of a workpiece or tool to be clamped, and a clamping mechanism (6), a stop element (9) that can be axially adjusted by means of an adjusting device (12) being provided for axial positioning of the shank in the receptacle (4), such that the adjusting device (12) is configured as a worm gear drive having a worm (13) rotatably mounted transversely to the receptacle (4) in the chuck body (1) and a worm gear (14) arranged coaxially with the receptacle (4).

The present invention concerns a clamping chuck, in particular an expansion chuck, having a dimensionally stable chuck body in which is embodied a central receptacle for the shank of a workpiece or tool to be clamped, and having a clamping mechanism for securing in the receptacle a shank inserted into the receptacle, a stop element that can be axially adjusted by means of an adjusting device being provided for axial positioning of the shank in the receptacle.

Clamping chucks of this kind are known in a variety of embodiments, and are used principally for securing a tool shank, e.g. a drill or milling cutter shank, or also workpieces, in the working spindle of a corresponding machine tool. For axial positioning of the shank in the receptacle of the chuck body, the known clamping chucks usually have an axial stop which projects from the machine side into the receptacle and can be moved axially by means of an adjusting device.

DE Published Examined Application 19 04 536, for example, discloses a clamping chuck in which the axial stop is equipped with external trapezoidal threads that are in engagement with trapezoidal threads of an axially fixed adjusting nut. Rotation of the axial stop is prevented by a pin that engages into a longitudinal groove of the axial stop.

WO90/10517 furthermore discloses a clamping chuck in which an axially displaceable, centeredly arranged, and nonrotatable adjusting stem, which is acted upon for axial adjustment by a rotationally actuated adjusting drive, serves as axial stop for the tool or workpiece to be clamped. The adjusting stem is equipped for this purpose with axial rack teeth corresponding to a toothed rack, which mesh with an adjusting drive that is embodied as a spur gear and is set tangentially with respect to the adjusting stem. A set screw equipped with the stop element is provided for immobilization of the adjusting stem following alignment.

In addition to these clamping chucks in which actuation of the axial adjusting devices is accomplished from the side in a radial direction, DE-U 93 01 918.1 discloses a clamping chuck in which the adjusting drive is embodied as a cone that is set obliquely with respect to the longitudinal axis of the axial stop and is equipped on its conical surface with spiral threads that are in engagement with external threads on the axial stop.

Although the known adjusting devices have proven successful in practice, it is nevertheless often desirable to be able to perform axial positioning of the stop element with even greater accuracy and precision.

It is therefore the object of the present invention to describe a clamping chuck of the kind cited initially that allows highly accurate axial positioning of the stop element.

This object is achieved, according to the present invention, substantially by the fact that the adjusting device is configured as a worm gear drive having a worm rotatably mounted transversely to the receptacle in the chuck body and a worm gear arranged coaxially with the receptacle, the stop element being coupled to the worm gear and retained in the chuck body in such a way that a rotary motion of the worm gear is converted into an axial motion of the stop element.

The configuration of the worm gear drive provided according to the present invention, with a worm and a worm gear meshing therewith, makes it possible to implement any desired reduction ratio of the rotary motion and thus any desired precision adjustment of the stop element coupled to the worm gear. Preferably, a reduction ratio of 1:5 to 1:20 can be implemented.

According to a variant of the invention, provision is made for the stop element to be retained on the worm gear nonrotatably but axially displaceably, and to have external threads that are in engagement with internal threads of the chuck body. This configuration makes it possible, in addition or alternatively to the reduction from the worm to the worm gear, to influence the axial adjustment of the stop element by way of the thread pitches. The greater the thread pitch, the more the stop element moves for each revolution of the worm gear in the axial direction. This configuration thus makes it possible to achieve particularly precise setting of the stop element.

In a development of this embodiment, the stop element can be of sleeve-like configuration and can be arranged displaceably on a stem that is connected, in particular detachably, to the worm gear. It is advantageous in this case if the stem has externally, and the stop element internally, segments that are in positive engagement with each other, by way of which the nonrotatable connection between the components is created while retaining axial adjustability of the stop element. The segments can be embodied, for is example, as internally and externally hexagonal segments.

In this embodiment, the worm gear/stem arrangement is preferably mounted in the chuck body by means of a guide bushing, arranged in the chuck body and in particular screwed thereinto, that can additionally contribute to the axial positioning of the arrangement in the chuck body.

According to an advantageous embodiment of the invention, the worm gear/stem arrangement is equipped with a through bore, in particular arranged centeredly, that provides unimpeded passage of coolant to the shank to be clamped.

According to a further variant of the invention, provision is made for the stop element to pass through the worm gear and to be retained therein nonrotatably but axially displaceably, and for the stop element to have external threads which are in engagement with internal threads of a guide bushing retained in the chuck body. This embodiment possesses the same advantages as the first variant cited previously, but has the virtue of making do with fewer components, since an additional stem is not necessary.

Regarding further embodiments of the invention, reference is made to the dependent claims and to the description below of an exemplary embodiment referring to the appended drawings, in which:

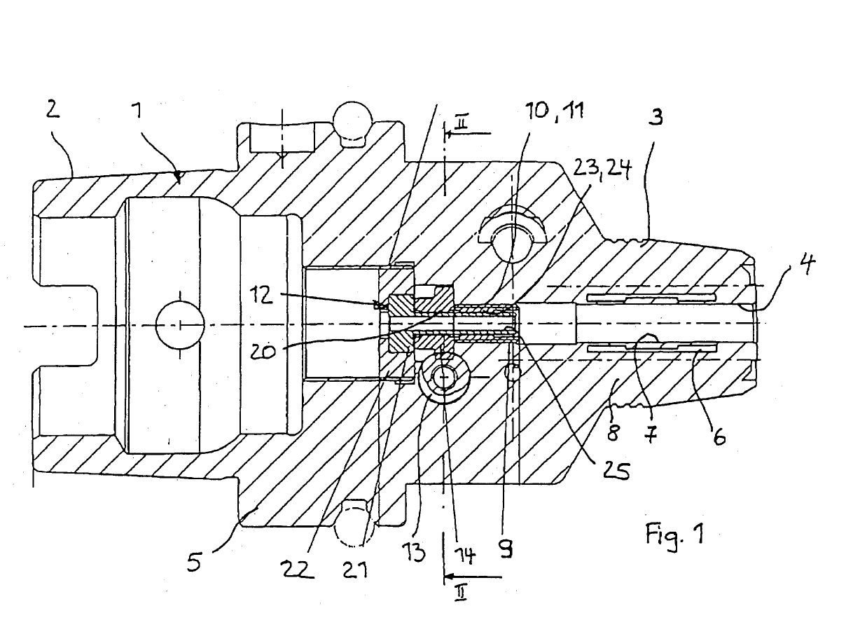

FIG. 1 shows an embodiment of a clamping chuck according to the present invention in a sectioned side view;

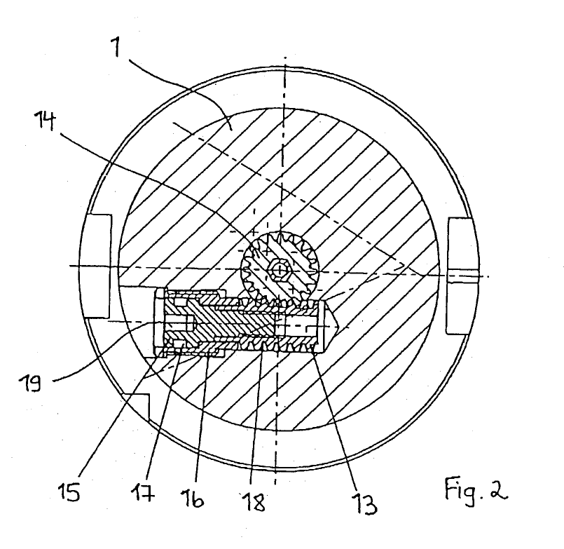

FIG. 2 shows the clamping chuck of FIG. 1 in section along line 11-11;

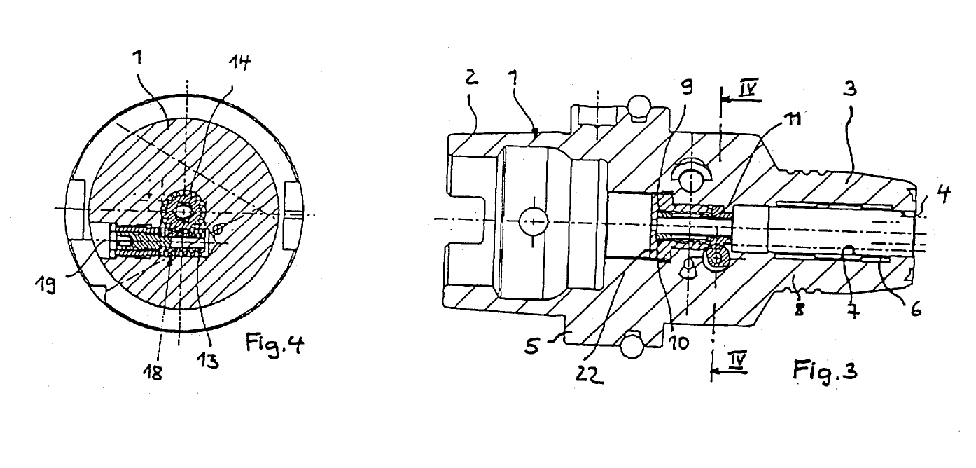

FIG. 3 shows a further embodiment of a clamping chuck according to the present invention in a sectioned side view; and

FIG. 4 shows the clamping chuck of FIG. 3 in section along line IV-IV.

FIGS. 1 and 2 depict a clamping chuck according to the present invention that is embodied as an expansion chuck. The clamping chuck comprises a chuck body 1 made of a dimensionally stable material that has, in a manner known per se, a mounting taper 2 for chucking into a receiving apparatus (not depicted) of a rotationally driven working spindle of a machine tool. Provided at the other end of chuck body 1 is a connector shaft 3 having a central receiving bore 4 into which the shank (in this case, cylindrical) of, for example, a drilling tool can be inserted; and a central part 5 of enlarged diameter is located between mounting taper 2 and connector shaft 3.

For securing the shank in receiving bore 4, there is depicted in connector shaft 3 of chuck body 1 an expansion clamping mechanism of which the drawing depicts only a narrow annular chamber 6 that is arranged around receiving bore 4 and oriented coaxially therewith. Annular chamber 6, whose axial length corresponds approximately to the necessary clamping range, is delimited toward receiving bore 4 by a relatively narrow inner wall 7, and radially externally by an outer wall 8 whose wall thickness is several times greater than the wall thickness of inner wall 7. Annular chamber 6 is filled with a hydraulic medium such as, for example, oil, and communicates (in a manner not depicted) via a conduit configured in chuck body 1 with a hydraulic medium source, by way of which it can have pressure applied to it in order to clamp a component. The pressure medium source can be constituted, in a manner known per se, by a cylindrical space, configured in chuck body 1, that is closed off at the end by a piston-like actuating member that can be screwed into the cylindrical space to elevate the pressure, or screwed out of it to decrease the pressure. This hydraulic pressure is transferred via the conduit to annular chamber 6, and brings about an elastic bulging of inner wall 7 until the latter immovably surrounds a shank inserted into receiving bore 4, and simultaneously a radial bulging of outer wall 8 until the latter lies against the inner wall of a tool that is set in place.

For axial positioning of the shank in receiving bore 4, a stop element 9 is provided which has external threads 10 and is screwed into a threaded segment 11 of receiving bore 4. Stop element 9 can be rotated by means of an adjusting device 12 and thereby axially adjusted. Adjusting device 12 is embodied as a worm drive, and comprises a worm 13 rotatably mounted in chuck body 1 transversely to receiving bore 4, and a worm gear 14, arranged coaxially with receptacle 4 and connected nonrotatably to stop element 9, that meshes with worm 13. In specific, worm 13, as is readily evident from FIG. 1, is of two-part configuration and comprises a drive screw 15 that is mounted rotatably but axially immovably in a bearing bushing 16 screwed into chuck body 1, the annular gap between bearing bushing 16 and drive screw 15 being sealed by an O-ring 17 to prevent the emergence of coolant, and a worm element 18 that is immovably connected (in this case thread-joined) to drive screw 15. Drive screw 15 has, at its end facing out of chuck body 1, an internally hexagonal member 19 for connection with an actuation tool.

In the embodiment depicted, connection between worm gear 14 and stop element 9 is accomplished by way of a stem 20 that passes axially through worm gear 14 and is nonrotatably connected to it by way of a stem/groove connection or the like. On the one side of worm gear 14, stem 20 has a flange-like head 21 that is rotatably mounted and oriented in chuck body 1 coaxially with receiving bore by means of a guide bushing 22 screwed into chuck body 1, the adjusting screw/stem arrangement being positioned axially between guide bushing 22 and a shoulder of chuck body 1.

On the other side of worm gear 14, stem 20 has a connection segment 23 that engages into stop element 9 that is configured in sleeve-like fashion, and is connected to it in such a way that stop element 9 cannot rotate with respect to stem 20 but can be axially displaced. For this purpose, in the embodiment depicted, connection segment 23 is configured as an external hexagonal member and the inner surface of the sleeve-shaped stop element 9 is equipped with an internally hexagonal segment 24, which are in engagement with one another.

In the exemplary embodiment depicted, stem 20 has an axial passthrough hole 25 through which, during operation, coolant can flow unimpededly to connector shaft 3.

To adjust stop element 9, worm 13 is turned with a suitable tool such as, for example, a socket wrench with hexagonal bit. This rotation of worm 13 is converted, with a reduction ratio of 1:10, into a rotary motion of worm gear 14 and thus also of stem 20 and of stop element 9 nonrotatably connected to stem 20; and the rotary motion of stop element 9 results in turn, by way of the engagement of its external threads 10 with threaded segment 11 of receiving bore 4, in an axial motion of stop element 9 which slides on external hexagonal member 23 of stem 20.

FIGS. 3 and 4 depict a further embodiment of a clamping chuck according to the present invention. This clamping chuck possesses the same basic construction as the clamping chuck depicted in FIGS. 1 and 2, with a chuck body 1 made of a dimensionally stable material that has a mounting taper 2 for chucking into a receiving apparatus (not depicted) of a working spindle. Provided at the other end of chuck body 1 is a connector shaft 3 having a central receiving bore 4 into which the shank of a tool can be inserted. In order to secure the shank in receiving bore 4, there is provided in chuck body 1 an expansion clamping mechanism as has already been described in connection with the explanation of FIG. 1.

Axial positioning of the shank in receiving bore 4 is accomplished by way of a stop element 9 which has external threads 10 that are in engagement with internal threads 11 of a guide bushing 22 that is screwed into chuck body 1 coaxially with receiving bore 4. Stop element 9 can be rotated by means of a worm gear drive 12 and thereby adjusted. Worm gear drive 12 comprises a worm 13 rotatably mounted in chuck body 1 transversely to receiving bore 4, and a worm gear 14, arranged coaxially with receptacle 4 and nonrotatably connected to stop element 9, that meshes with worm 13. Worm 13 has the same construction as worm 13 of the first embodiment depicted in FIGS. 1 and 2, and to avoid repetition will therefore not be described again.

Stop element 9 passes through worm gear 14 and is connected thereto in such a way that it cannot rotate with respect to worm gear 14 but can be axially displaced.

For adjustment of stop element 9, worm 13 is turned with a suitable tool such as, for example, a socket wrench with hexagonal bit. The rotation of worm 13 is converted, with a reduction ratio, into a rotary motion of worm gear 14 and thus also of stop element 9. The rotary motion of stop element 9 results in turn, by way of the engagement of its external threads 10 with internal threads 11 of guide bushing 22, in an axial motion of stop element 9.

1. A clamping chuck, in particular an expansion chuck, having a dimensionally stable chuck body (1) in which is embodied a central receptacle (4) for the shank of a workpiece or tool to be clamped, and having a clamping mechanism (6) for securing in the receptacle (4) a shank inserted into the receptacle (4), a stop element (9) that can be axially adjusted by means of an adjusting device (12) being provided for axial positioning of the shank in the receptacle (4), characterized in that the adjusting device (12) is configured as a worm gear drive having a worm (13) rotatably mounted transversely to the receptacle (4) in the chuck body (1) and a worm gear (14) arranged coaxially with the receptacle (4), the stop element (9) being coupled to the worm gear (14) and retained in the chuck body (1) in such a way that a rotary motion of the worm gear (14) is converted into an axial motion of the stop element (9).

2. The clamping chuck as defined in claim 1, characterized in that the stop element (9) is retained on the worm gear (14) nonrotatably but axially displaceably, and has external threads (10) that are in engagement with internal threads (11) of the chuck body (1).

3. The clamping chuck as defined in claim 2, characterized in that the stop element (9) is of sleeve-like configuration and is arranged displaceably on a stem (20) that is connected, in particular detachably, to the worm gear (14).

4. The clamping chuck as defined in claim 3, characterized in that the stem (20) has externally, and the stop element (9) internally, segments (23, 24) that are in positive engagement with each other and are embodied in particular as an internally and an externally hexagonal member.

5. The clamping chuck as defined in claim 3 or 4, characterized in that the worm gear/stem arrangement (14, 20) is mounted in the chuck body (1) by means of a guide bushing (22) provided in the chuck body (1).

6. The clamping chuck as defined in claim 5, characterized in that the guide bushing (22) is screwed into the chuck body (1).

7. The clamping chuck as defined in claim 5 or 6, characterized in that the worm gear/stem arrangement (14, 20) is axially positioned in the chuck body (1) between the guide bushing (22) and a shoulder of the chuck body (1).

8. The clamping chuck as defined in one of claims 2 through 7, characterized in that the worm gear/stem arrangement (14, 20) is equipped with an axial and, in particular, centrally configured through bore (25) through which a coolant can be delivered to the receptacle (4).

9. The clamping chuck as defined in claim 1, characterized in that the stop element (9) passes through the worm gear (14) and is retained therein nonrotatably but axially displaceably, and the stop element (9) has external threads (10) which are in engagement with internal threads (11) of a guide bushing (22) retained in the chuck body (1).

10. The clamping chuck as defined in claim 9, characterized in that the worm gear (14) is axially positioned in the chuck body (1) between the guide bushing (22) and a shoulder of the chuck body (1).

11. The clamping chuck as defined in one of the foregoing claims, characterized in that the worm (13) has on its outwardly directed end means (19) for connection with an actuation tool.

12. The clamping chuck as defined in one of the foregoing claims, characterized in that the worm (13) is mounted rotatably and axially immovably by means of a bearing bushing (16) provided in the chuck body (1), the annular gap between bearing bushing (16) and worm (13) preferably being sealed to prevent the emergence of coolant.
